(19) United States
(12) Patent Application Publication
(10) Pub. No.: US 2006/0236284 A1
(43) Pub. Date: Oct. 19, 2006

(54) Design method by estimating signal delay time with netlist created in light of terminal line in macro and program for creating the netlist

(75) Inventor: Kentaro Kawahara, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/402,834

(22) Filed: Apr. 13, 2006

(30) Foreign Application Priority Data
Apr. 19, 2005 (JP) 2005-120781

(51) Int. Cl. G06F 17/50; G06F 9/45

(52) U.S. Cl. 716/10; 716/12; 716/6

(57) ABSTRACT

A design method that implements automatic layout based on a first netlist created from a design circuit includes laying out a plurality of functional blocks of the design circuit based on the first netlist, creating a second netlist where information on line resistance and line capacitance of a line between the functional blocks is added to the first netlist, creating a third netlist by adding information on line resistance and line capacitance of a line connected to a terminal of each functional block from inside of each functional block to the second netlist, and estimating a delay time from information of the third netlist.

### BACKGROUND OF THE INVENTION

1. Field of the Invention

The present invention relates to a design method that estimates signal delay time by using a netlist which is created in light of terminal lines in a macro and a program for creating the netlist. Particularly, the present invention relates to a design method that estimates signal delay time by using a netlist which is created in light of the capacitance and resistance of terminal lines in a macro and a program for creating the netlist.

2. Description of Related Art

With the recent increase in scale of large scale integration (LSI), the function of the macro incorporated into the LSI to implement prescribed functions becomes complex. Further, with the recent miniaturization of LSI structure, the width of the internal lines narrows accordingly. Consequently, the resistance of the internal line affects signal delay more largely.

A conventional delay calculation method is disclosed in Japanese Unexamined Patent Application Publication No. 11-259555, for example. FIG. 6 shows a flowchart of a conventional typical design method. The flowchart of FIG. 6 is described hereinafter in detail.

The method first performs the circuit design 601 to connect predesigned macros. From the circuit designed in the circuit design step 601, the method creates a netlist a 602 that contains circuit connection information. According to the created netlist a 602, the method then performs the layout in the automatic layout step 603 by using an automatic layout tool or the like. Based on this layout, the method creates a netlist A 604 that contains information on the line resistance and line capacitance of the lines connected to the macro and the input terminals capacitance of the macro. Using the created netlist A 604, the method implements delay simulation 605. If the result of the delay simulation shows that delay is within the range of specification, the method ends the design. If, on the other hand, the simulated delay is outside the range of specification, the method returns to the automatic layout step 603 or the circuit design step 601 for redesign.

FIG. 7 is the circuit diagram showing the macro used in the netlist A 604, the line resistance and line capacitance of the line connected to the macro and the input capacitance of the macro. The resistors and capacitors connected a macro 701 are described herein with reference to FIG. 7.

Referring to FIG. 7, an input terminal IN 1 of the macro 701 is connected to INST 1 through NET 1. The INST 1 may be another macro, an input buffer, an LSI pad or the like which is connected to the input terminal IN 1. The NET 1 is a circuit that models the line resistance and line capacitance of the line between the macro 701 and the INST 1. Further, the modeling of the input terminal capacitance is connected to the input terminal IN 1 on the inside of the macro. The input terminal capacitance may be a sum of the gate capacitance of an input buffer and the line capacitance from the input terminal IN 1 to the device connected first in the macro, for example. In another macro input terminal, such as an input terminal IN 2, the resistance and the capacitance are modeled in the same manner.

An output terminal OUT 1 is not connected to any device inside the macro 701. The output terminal OUT 1 is connected to INST 3 through NET 3. The INST 3 may be another macro, an output buffer, an LSI pad or the like which is connected to the output terminal OUT 1. The NET 3 is a circuit that models the line resistance and line capacitance of the line between the macro 701 and the INST 3.

With the use of the above circuits that model the macro 701 and the lines connected thereto, the overall signal delay including the signal delay that occurs in the peripheral lines of the macro can be simulated.

However, it has now been discovered that since the conventional design method considers only the input terminal capacitance as the line delay component inside the macro, there is a large difference between the delay time of an actual LSI and the calculated value of the delay simulation and thereby the actual LSI does not operate in some cases. It is necessary to perform the circuit design again in such a case, which increases a design period. In order to prevent this error, it is necessary to place constraints to minimize the line length from the input terminal and output terminal of the macro to the first connected device in the layout process, which increases a design time.

### SUMMARY OF THE INVENTION

According to an aspect of the present invention, there is provided a design method that implements automatic layout based on a first netlist created from a design circuit, which includes laying out a plurality of functional blocks of the design circuit based on the first netlist, creating a second netlist where information on line resistance and line capacitance of a line between the functional blocks is added to the first netlist, creating a third netlist by adding information on line resistance and line capacitance of a line connected to a terminal of each functional block from inside of each functional block to the second netlist, and estimating a delay time from information of the third netlist.

The present invention takes account of not only the line resistance and line capacitance between functional blocks of a design circuit but also the line resistance and line capacitance of a line connected to a terminal of a functional block from inside of the functional block. It is thereby possible to estimate signal delay time that occurs in the line from the terminal of the functional block to the internal device of the functional block. This increases the estimation accuracy of signal delay time. The increase in accuracy of estimating the operation of an actual LSI in design phase brings the LSI in design phase nearer to perfection. Consequently, the present invention enables the reduction of redesign of LSI and the shortening of the design time.

### BRIEF DESCRIPTION OF THE DRAWINGS

The above and other objects, advantages and features of the present invention will be more apparent from the following description taken in conjunction with the accompanying drawings, in which:

FIG. 1 is a flowchart of a design method according to an embodiment of the present invention;

FIG. 2 is a circuit diagram of a macro represented in a netlist A according to an embodiment of the present invention;

FIG. 3 is a circuit diagram of a macro represented in a description file on terminal lines in a macro according to an embodiment of the present invention;

FIG. 4 is circuit diagram of a macro represented in a netlist A′ according to an embodiment of the present invention;

FIG. 5 is a flowchart of a netlist manipulation program according to an embodiment of the present invention;

FIG. 6 is a flowchart of a conventional design method; and

FIG. 7 is a circuit diagram of a macro represented in a conventional netlist A.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

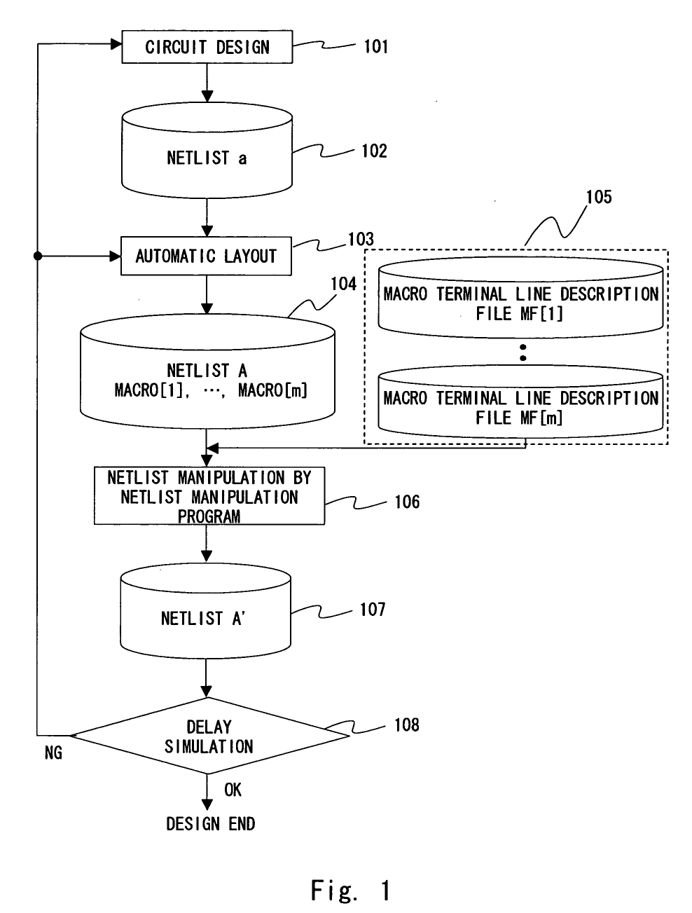

FIG. 1 shows a flowchart of a design method according to a first embodiment of the present invention. The design method according to the first embodiment is described hereinafter with reference to FIG. 1. The method first designs an overall LSI that has a plurality of functional blocks including a macro, an input/output buffer and an input/output pad in the circuit design step 101. It then creates a net list a 102 which is a first netlist of the circuit designed in the circuit design step 101. According to the created netlist a 102, the method makes the layout of the LSI in the automatic layout step 103 by performing automatic arrangement and wiring of functional blocks. After that, the method extracts the line resistance and line capacitance of the lines connecting the functional blocks and the input terminal capacitance of the macro from the formed layout and then creates a netlist A 104 which is a second netlist that contains information on the extracted line resistance, line capacitance and macro input terminal capacitance. Then, the method implements the manipulation that adds information of a pre-prepared description file 105 of terminal lines in the macro to the netlist A 104 in the netlist manipulation program 106. The netlist manipulation program 106 creates a netlist A′ 107 which is a third netlist that contains the netlist A 104 and the macro terminal line description file. The macro terminal line description file contains information on the line resistance and line capacitance of the line connected from the inside of the macro to the terminal of the macro. After that, the method implements the delay simulation 108 that calculates signal delay time in delay simulator with the use of the netlist A′ 107.

If the delay time calculated in the delay simulation 108 is within the range of specification, the method ends the design process. If, on the other hand, it is outside the range of specification, the method returns to the automatic layout step 103 or the circuit design step 101 and repeats the flow until the delay time falls within the range of specification.

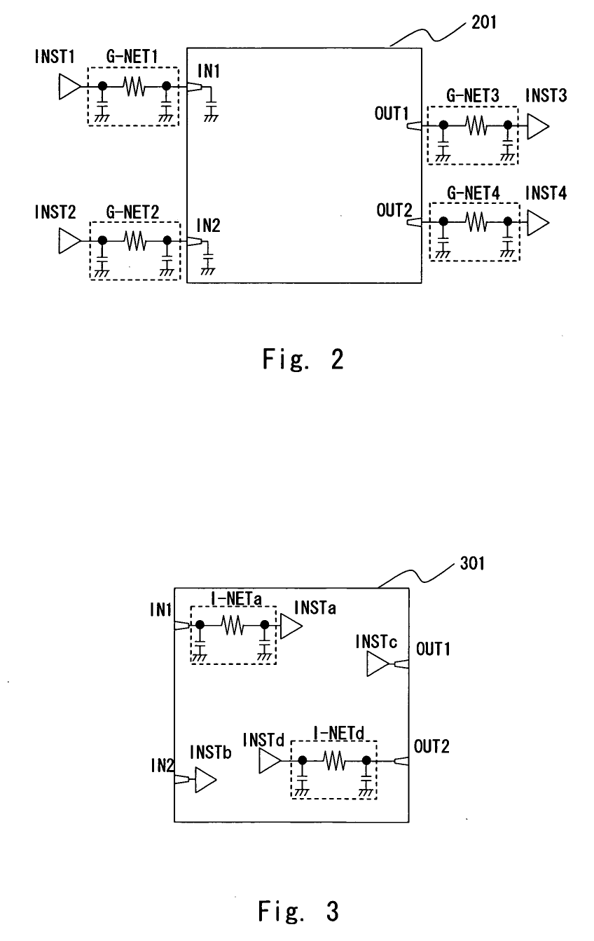

The netlist A104 which is created based on the layout made in the automatic layout step 103 is described herein. FIG. 2 is the circuit diagram showing line resistors and line capacitors which are connected to the macro represented in the netlist A 104. The circuit diagram of FIG. 2 includes the macro 201, instances INST 1 to 4 connected to the macro 201, and first circuits (e.g. G-NET 1 to 4) respectively connected between each INST and macro terminal.

The instances INST 1 to 4 may be another macro, an input/output buffer, an LSI pad or the like which is connected to the macro 201. The instances INST 1 to 4 are referred to hereinbelow as INST unless otherwise noted. The G-NET 1 to 4 are the circuit that model the line resistance and line capacitance between the terminal of the macro 201 and the corresponding INST. For example, each G-NET includes a first capacitor whose one terminal is connected to the line on the side of the instance and the other terminal is connected to the ground, a second capacitor whose one terminal is connected to the line on the side of the macro terminal and the other terminal is connected to the ground, and a resistor whose one terminal is connected to the line on the side of the instance and the other terminal is connected to the line on the side of the macro terminal. The values of the resistor and the first and second capacitors of the G-NET 1 to 4 can be calculated from the layout. The G-NET 1 to 4 are referred to hereinbelow as G-NET unless otherwise noted.

Further, a macro input terminal capacitor is connected between the input terminal of the macro 201 and the ground. The input terminal capacitance may be a sum of the line capacitance from the input terminal to the device which is in the first stage of the macro and connected to the input terminal and the gate capacitance of the device in the first stage of the macro.

The netlist A describes the overall LSI, including the macro and the line resistance and capacitance connected to the macro.

FIG. 3 is the circuit diagram of the macro which is defined in a pre-prepared description file of terminal lines in the macro. The circuit of the macro represented in the macro terminal line description file is described hereinafter with reference to FIG. 3. The terminal line circuits inside the macro include I-NET a connected to the input terminal IN 1 of the macro 301, the first-stage instance INST a connected to the input terminal IN 1 through the I-NET a, I-NET d connected to the output terminal OUT 2, and the instance INST d connected to the terminal OUT 2 through the I-NET d. The instance INST b is connected to the input terminal IN 2, and the instance INST c is connected to the output terminal OUT 1. The instances INST a, b may be input buffers, for example. The instances INST c, d may be output buffers, for example.

Each of the I-NET a and d is a second circuit that models the line resistance and line capacitance between the terminal of the macro 301 and the instance corresponding to the terminal. For example, each I-NET includes a third capacitor whose one terminal is connected to the line on the side of the instance and the other terminal is connected to the ground, a fourth capacitor whose one terminal is connected to the line on the side of the macro terminal and the other terminal is connected to the ground, and a resistor whose one terminal is connected to the line on the side of the instance and the other terminal is connected to the line on the side of the macro terminal. The values of the resistor and the third and fourth capacitors of the I-NET a and d can be calculated from the layout. The I-NET a and d are referred to hereinbelow as I-NET unless otherwise noted.

A circuit equivalent to the I-NET a, d is not connected to the input terminal IN 2 nor the output terminal OUT 1 in FIG. 3. This is because a distance from the terminal to the instance is so short that line resistance and line capacitance are as small as negligible.

By using the netlist A 104 and the macro terminal line description file 105 as input files, the netlist manipulation program creates a new netlist A′ 107 that adds the two files together. FIG. 5 is the flowchart which shows the way the netlist manipulation program creates the netlist A′ 107.

The operation of the netlist manipulation program in the case where the netlist A 104 has m-number of macros each of which has n-number of terminals, for example, is described hereinafter in detail with reference to FIG. 5. The netlist manipulation program first reads the M-th macro M in the netlist A 104 (Step 501). For example, if the initial value of M is 1, it reads the macro 1, which is the first macro. The program then stores the read macro M into memory (Step 502).

Then, the netlist manipulation program reads the N-th terminal name of the macro M (Step 503). If the initial value of N is 1, for example, it reads the terminal name of the first terminal of the macro 1. The program then stores the read terminal name into MAC[1][1] of memory MAC[M][N] (Step 504).

Further, the program reads the macro terminal line description file 105 which corresponds to the macro M (Step 505). For example, it reads the macro terminal line description file MF[1] which corresponds to the macro 1. The program then stores the read MF[1] into memory (Step 506). Then, it reads the L-th terminal name in the description file MF[1] (Step 507). If the initial value of L is 1, for example, it reads the terminal name of the first terminal. The program then stores the read terminal name into TP[1][1] of memory TP[M][L] (Step 508).

After that, the program compares the terminal name of the macro M which has been stored in the memory MAC [M] [N] in Step 504 and the terminal name in the description file MF[M] which has been stored in the memory TP[M][L] in Step 508 (Step 509). If the comparison result shows that the stored terminal names match with each other, the program inserts I-NET which is connected to the L-th terminal in the macro terminal line description file MF[M] between the N-th terminal of the macro M and the G-NET connected to the terminal in the netlist A (Step 510).

If, on the other hand, the comparison result in Step 509 shows that the terminal names do not match, the program adds one to the terminal number L in the file MF[M] and repeats this process until the terminal number L reaches the terminal number n (Step 511). For example, if the first terminal name TP[1][1] in the file MF[1] and the terminal name MAC[1][1] do not match, the program returns to Step 507 and reads the second terminal name TP[1][2]. This process is repeated until the terminal names match or the terminal number L becomes the same as the number n of terminals. The program searches the first terminal to the n-th terminal of the file MF[M] and, if the terminal names do not match, proceeds to the next step.

When Step 510 or Step 511 completes, the program adds one to the terminal number N of the macro M. This process is repeated until the terminal number N equals the number n of terminals of the macro M (Step 512). For example, if the process of Step 510 or Step 511 completes on the first terminal of the macro 1, the program returns to Step 503 and reads the second terminal name of the macro 1. After that, the program again repeats the process from Step 507 to Step 511. If the process from Step 507 to Step 511 completes, the program again returns to Step 503 and reads the next terminal name of the macro M. This process is repeated until the reading completes on all the terminals of the macro M. The process proceeds to the next step when the terminal number N of the macro M becomes the same as the number n of terminals.

When Step 512 completes, the process adds one to the macro number M of the netlist A. This process is repeated until the macro number M equals the number m of the macros (Step 513). For example, if the process of Step 510 or Step 512 completes on the first macro 1, the program returns to Step 501 and reads the second macro 2. After that, the program performs Step 502 to Step 512. This process is performed on all the macro and, when the macro number M becomes the same as the number m of macros, terminates the process.

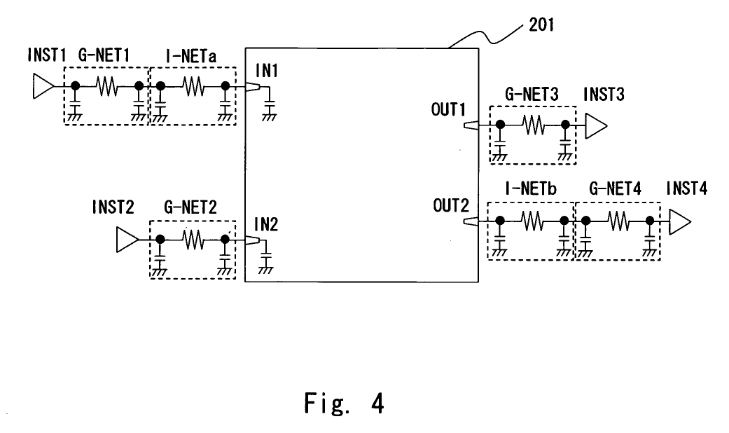

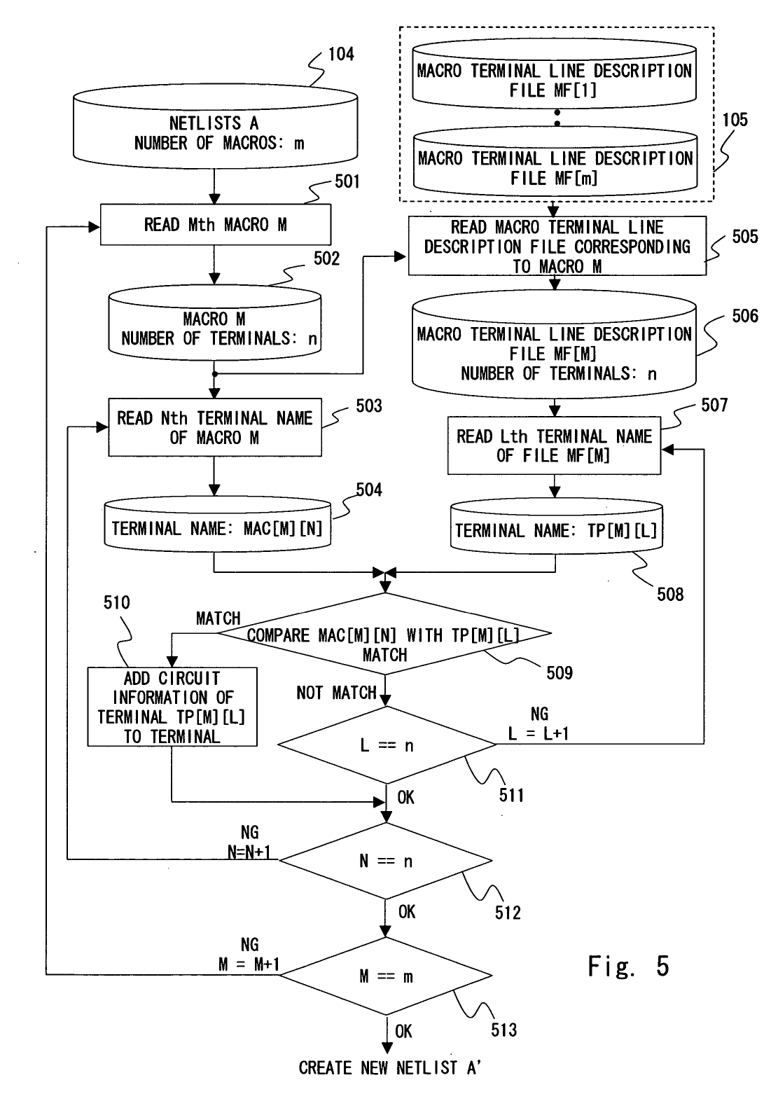

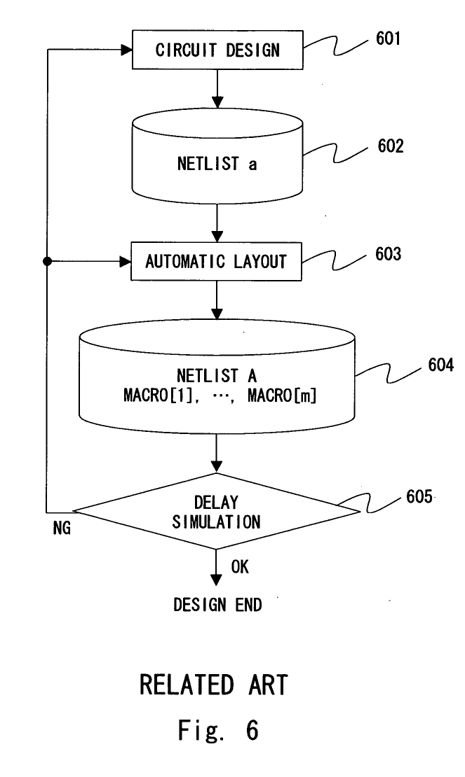

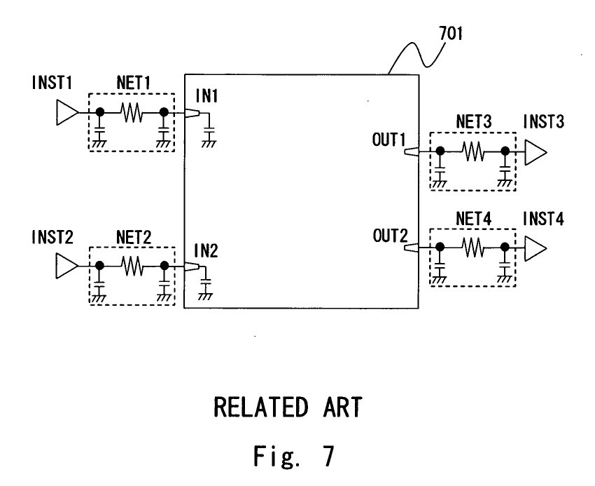

As a result of Steps 501 to 513, information on I-NET is added to all terminals of all macros, and a new netlist A′ 107 is thereby created. FIG. 4 is the circuit diagram showing the macro and the line resistors and line capacitors connected to the macro which are described in the netlist A′ 107. The circuit defined in the netlist A′ 107 is described hereinafter in detail with reference to FIG. 4. The circuit of FIG. 4 includes the macro 201 described in the netlist A 104, G-NET described in the netlist A 104, INST described in the netlist A 104, and I-NET described in the macro terminal line description file 105. A combination of G-NET and I-NET serves as a third circuit.

Inside the macro 201, an input terminal capacitor is connected between the input terminal IN 1 and the ground. Connected to the input terminal IN 1 is INST 1 through G-NET 1 and I-NET a. G-NET 1 is described in the netlist A 104 while I-NET a is described in the macro terminal line description file 105. I-NET a is inserted between the input terminal IN 1 and G-NET 1 by the netlist manipulation program. The input terminal capacitor connected between the input terminal IN 1 and the ground may be included in the macro terminal line description file 105. In this case, the information on the input terminal capacitor is deleted from the netlist A 104.

Since there is no description on I-NET in the input terminal IN 2 of the macro terminal line description file 105, the input terminal IN 2 of the macro 201 is described in the netlist A′ 107 in the same way as in the netlist A 104.

Further, since there is no description on I-NET in the output terminal OUT 1 of the macro terminal line description file 105, the output terminal OUT 1 of the macro 201 is described in the netlist A′ 107 in the same way as in the netlist A 104.

Connected to the macro output terminal OUT 2 is INST 4 through G-NET 4 and I-NET d. G-NET 4 is described in the netlist A 104 while I-NET d is described in the macro terminal line description file 105. I-NET d is inserted between the output terminal OUT 2 and G-NET 4 by the netlist manipulation program.

The present invention adds, by the netlist manipulation program, the information on the line resistance and line capacitance of the lines connected from the inside of the macro to the terminals of the macro to the netlist A 104 which is created based on the layout in the automatic layout step, thereby creating the new netlist A′ 107. The use of the netlist A′ 107 enables the delay simulation that considers not only the signal delay due to the line connected to the macro terminal from the outside but also the signal delay due to the line connected to the macro terminal from the inside. Implementation of highly accurate delay simulation brings LSI in design phase nearer to perfection and thereby prevents the reversion to an earlier step in the semiconductor design process, thus reducing the time for the semiconductor design.

Further, this invention allows the line resistance of the line connected to the macro terminal from inside and the line delay to be reflected on the delay simulation, which increases the freedom of layout in the macro. For example, if a distance from the macro input terminal to the first-stage input buffer is long, there has been a large difference between the result of the delay simulation and the signal delay in the actual semiconductor apparatus in conventional design method because the line resistance and line capacitance inside the macro are not considered therein. On the other hand, the present invention allows consideration of the line resistance and line capacitance inside the macro, thus enables the reduction in the difference between the result of the delay simulation and the signal delay in the actual semiconductor apparatus. The present invention thereby enables the layout with less layout constraints, allowing easier design.

The present invention is not limited to the above embodiments but may be altered in various ways. For example, the netlist manipulation program does not necessarily follow the flowchart of the above embodiment as long as it can create the netlist A′ 107 where the information of the macro terminal line description file 105 is added to the netlist A 104.

Further, in the case where layout is already done inside the macro 201 and the automatic layout step 103 only needs to dispose the laid out macro and connects the input and output terminals of the macro to external devices, the present invention provides the easy and highly accurate delay simulation.

In such a case, it is feasible to calculate the signal transmission delay time inside the macro 201 in advance and generate a library, so that the delay simulation 108 skips the delay simulation on the delay inside the macro and calculates the overall signal transmission delay time highly accurately by using the signal transmission delay time which has been stored in the library beforehand.

Specifically, if the signal input through the input terminal IN 1 is transmitted through the inside of the macro 301 and then output through the output terminals OUT 1 and OUT 2, the signal transmission delay time from INST a to INST c and from INST a to INST d is calculated by delay simulation and delay calculation in advance and stored in the macro terminal line description file 105 as library. With the use of the delay time stored in the library, the delay simulation 108 can calculate the signal transmission delay time from INST a to INST c and from INST a to INST d that occurs inside the macro without actually implementing the delay simulation. For example, in the signal transmission path which starts from the start point INST 1, passes through IN 1, INST a, INST d, OUT 2 and reaches the end point INST 4, the signal transmission delay time while the signal starts the start point INST 1 and reaches the end point INST 4 can be calculated by adding the signal transmission delay time from INST a to INST d and the signal transmission delay time from INST d to INST 4 to the signal transmission time from INST 1 to INST a. Though it is necessary to calculate the signal transmission delay time from INST 1 to INST a and from INST d to INST 4 by implementing the delay simulation, the signal transmission delay time from INST a to INST d may be obtained by using the signal transmission delay time which is pre-stored in the macro terminal line description file 105.

This process allows skipping the delay simulation from INST a to INST d, thus enabling easy delay simulation. It further allows implementing delay simulation by taking the line resistance and line capacitance from the macro input terminal to the first-stage gate and from the output-stage gate to the output terminal into account, thus enabling highly accurate delay simulation.

The signal transmission delay time inside the macro is affected by power supply voltage, temperature, rounding of input wave form and soon. Pre-storing these variations into the library enables more highly accurate delay simulation.

It is apparent that the present invention is not limited to the above embodiment that may be modified and changed without departing from the scope and spirit of the invention.

What is claimed is:

1. A design method implementing automatic layout based on a first netlist created from a design circuit, comprising:
laying out a plurality of functional blocks of the design circuit based on the first netlist;
creating a second netlist where information on line resistance and line capacitance of a line between the functional blocks is added to the first netlist;
creating a third netlist by adding information on line resistance and line capacitance of a line connected to a terminal of each functional block from inside of each functional block to the second netlist; and
estimating a delay time from information of the third netlist.

2. The design method according to claim 1, wherein the addition of the information on line resistance and line capacitance of a line connected to a terminal of each functional block from inside of each functional block to the second netlist prepares a macro terminal line description file and adds information on the macro terminal line description file corresponding to the terminal of the functional block to be described in the second netlist.

3. The design method according to claim 2, wherein the macro terminal line description file corresponds to the functional block described in the second netlist, and described for a netlist of a circuit modeling line resistance and line capacitance are connected to a terminal of the functional block.

4. The design method according to claim 2, wherein the second netlist contains a first circuit modeling line resistance and line capacitance of a line between the functional blocks.

5. The design method according to claim 2, wherein the macro terminal line description file contains a second circuit modeling line resistance and line capacitance of a line from a terminal of the functional block to an internal device first-connected in the functional block.

6. The design method according to claim 5, wherein the third netlist contains a third circuit where the second circuit is inserted between the first circuit modeling line resistance and line capacitance of a line between the functional blocks and the terminal of the functional block.

7. The design method according to claim 1, wherein the second netlist contains a first circuit modeling line resistance and line capacitance of a line between the functional blocks.

8. The design method according to claim 1, wherein the third netlist contains a third circuit where the second circuit modeling line resistance and line capacitance of a line from a terminal of the functional block to an internal device first-connected in the functional block is inserted between the first circuit modeling line resistance and line capacitance of a line between the functional blocks and the terminal of the functional block.

9. A computer program product, in a computer readable medium, for causing a computer to execute estimation calculation of signal delay time in a design circuit, comprising instructions for:
laying out functional blocks of the design circuit based on a first netlist;
creating a second netlist where information on line resistance and line capacitance of a line between the functional blocks is added to the first netlist;
creating a third netlist by adding information-on line resistance and line capacitance of a line connected to a terminal of each functional block from inside of each functional block to the second netlist; and
causing estimation calculation of the delay time based on information of the third netlist.

10. A computer program product, in a computer readable medium, for causing a computer to execute delay time calculation of an electronic circuit including a functional block whose signal delay time from a first-stage gate to an output-stage gate in a signal path from a start point to an end point is pre-calculated, comprising instructions for:
with use of a functional block delay library prestoring signal transmission delay time from the first-stage gate to the output-stage gate of the functional block, line resistance and line capacitance from an input terminal of the functional block to the first-stage gate, and line resistance and line capacitance from the output-stage to an output terminal of the functional block, circuit connection information from the start point to the input terminal and circuit connection information from the output terminal to the end point,
calculating a first signal transmission delay time from the start point to the first-stage gate by adding line resistance and line capacitance from the input terminal to the first-stage gate to the circuit connection information from the start point to the input terminal;
calculating a second signal transmission delay time from the output-stage gate to the end point by adding line resistance and line capacitance from the output-stage gate to the output terminal to the circuit connection information from the output terminal to the end point; and
calculating a third signal transmission delay time from the start point to the end point by adding the first signal transmission delay time and the second signal transmission delay time to the signal transmission delay time from the first-stage gate to the output-stage gate contained in the functional block delay library.
